(19) United States
(12) Patent Application Publication
(10) Pub. No.: US 2004/0117082 A1
(43) Pub. Date: Jun. 17, 2004

(54) Device for transmitting measurements of a sensor to a central unit

(76) Inventors: Patric Bidou, Plaisance du Touch (FR); Georges Fonzes, Antibes (FR); Gerhard Goeser, Pentling (DE)

Correspondence Address: YOUNG & THOMPSON, 745 SOUTH 23RD STREET 2ND FLOOR, ARLINGTON, VA, 22202

(21) Appl. No.: 10/474,212

(22) PCT Filed: Mar. 8, 2002
(86) PCT No.: PCT/EP02/02547

(30) Foreign Application Priority Data
Apr. 4, 2001 (FR) 01/04589

(51) Int. Cl. G01M 17/02

(52) U.S. Cl. 701/33

(57) ABSTRACT

The method is carried out in a vehicle or similar, comprising the following steps: detection of the state of the vehicle (2) when stopped, the sensor measures a parameter such as pressure (6), the result of the measurement is stored in the sensor (10), the sensor analyses the measurement according to previous measurements (8), significant results of the analysis are stored inside the sensor (10), and when the vehicle begins once more to travel, significant data relating to events occurring since the last detected stop of the vehicle is transmitted (14) from the sensor to the central unit wherever applicable.

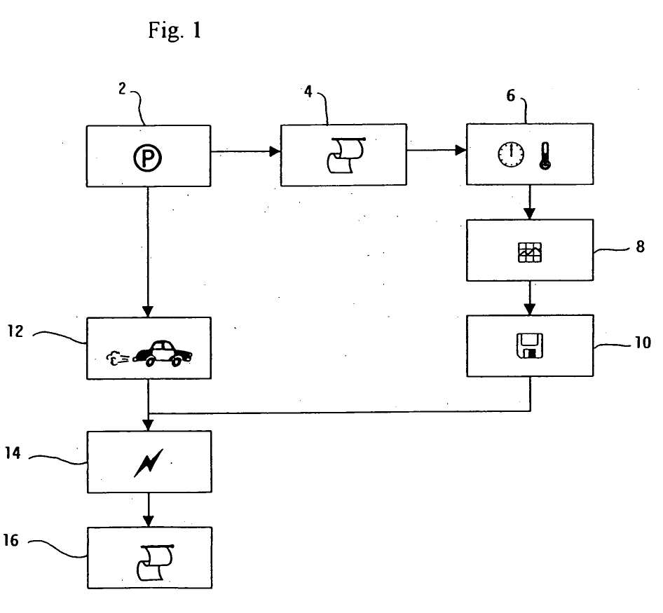

The present invention relates to a method of transmitting measurements from a sensor to a central unit. This method relates more particularly to the transmission of measurements, in particular of pressures and temperatures, from a sensor located in a tire of a motor vehicle wheel to a central control unit installed in the vehicle.

In order to check the pressure in a vehicle tire, particularly that of a motor vehicle, it is known to place a sensor in the corresponding tire. This sensor then measures the pressure, and possibly the temperature, and transmits these items of information by means of an incorporated radio transmitter to a central unit installed in the vehicle.

The sensor thus disposed in the tire is equipped with a battery for the electrical energy supply to the sensor and the transmitter. In order to conserve this battery, when the vehicle is stopped, the sensor continues to work normally but at a lower frequency. It can sometimes happen that during a stoppage the sensor is positioned in an area screened from radio transmission and cannot transmit the information that it is measuring to the central unit. If the vehicle then remains stopped for a long time, between two successive measurements transmitted to the central unit, the pressure difference may appear to be large. An alarm will be triggered to alert the driver although it could well be an entirely normal pressure variation due, for example, to a change in temperature and/or a pressure readjustment carried out by the user.

The purpose of the present invention is therefore to provide a method of transmitting measurements to the central unit that is more reliable than the devices of the prior art. This method will preferably allow the sensor to operate in such a way as to conserve the energy of the battery and not use a device more onerous than the existing devices for monitoring tire pressures.

For this purpose, the method that it proposes is a method of transmitting measurements from a sensor to a central unit by a wireless link, such as a radio link for example, in a motor vehicle or similar.

According to the invention, this method comprises the following steps:

detection of the stopped state of the vehicle,

measurement by the sensor of a parameter such as pressure for example,

storage of the result of the measurement within the sensor,

analysis, at the level of the sensor, of the measurement with reference to the preceding measurements,

storage of the significant results of the analysis within the sensor, and

when the vehicle is moving again, transmission by the sensor, if necessary, to the central unit of significant data on the events that have occurred since the last detected stoppage of the vehicle.

This system comprising the sensor and the transmitter disposed, for example, in the tire of the vehicle is not therefore limited to the measurement and sending of the results of the measurement to the central unit but is capable of producing a log and an analysis of the evolution of the measurement values in order to determine, in an autonomous manner, phenomena that are important to detect when the vehicle is stopped. It therefore becomes possible to detect a slowly evolving phenomenon from a rapidly evolving phenomenon.

In order to guarantee correct transmission of the information stored by the sensor, a plurality of transmissions are preferably carried out by the sensor to the central unit when a starting of the vehicle is detected.

The measurements taken by the sensor whilst the vehicle is stopped are for example taken at a predetermined frequency. The latter is preferably lower when the vehicle is stopped than when it is moving in order to conserve the energy necessary for the operation of the sensor and the transmitter.

When the vehicle starts again, the sensor advantageously transmits to the central unit only the information relating to a sudden and/or abnormal variation of the measured parameter. As the measured values have already been analyzed, it is useless to give all of these values to the central unit.

In the method according to the invention, the sensor measures, for example, both a pressure and a temperature.

During the analysis of the measurements taken, the sensor can calculate the derivative of the measured parameter with respect to time.

In order to be able to give date-logged information to the user, the sensor advantageously stores both the measurements taken and the dates on which they were taken.

Detection of the movement and/or the stoppage of the vehicle is for example carried out by an accelerometer.

The single FIGURE shows a flow chart illustrating a method according to the invention.

A method according to the invention relates to a vehicle provided with a device for monitoring the pressure in the tires. Such a device generally comprises, in each of the vehicle's tires, a sensor generally making it possible to measure the pressure and temperature and coupled with the transmitter. The latter generally transmits electromagnetic waves in the radio frequency (RF) band. The sensor and the transmitter are for example placed close to the valve of the corresponding wheel. With regard to a receiver corresponding to the transmitter, this is coupled to a central control united installed in the vehicle.

A device, such as an accelerometer for example, is located with each sensor in order to indicate if the vehicle is stopped or moving. Electronic control and management means, for example integrated with the sensor, determine, according to the moving or stopped state of the vehicle, the frequency of measurement of pressures and temperatures and the transmission of the measurements taken to the central unit. When the vehicle is stopped, the frequency for measuring the pressure and temperature is lower than when the vehicle is moving. The method according to the invention relates more particularly to the management of the measurements and the transmission of information to the central unit during the phases when the vehicle is stopped.

When an accelerometer, or similar device, detects that a wheel is stopped, (box 2) the management and control device coupled with the sensor of that wheel starts the program associated with the management procedure of the sensor and of its transmitter for a vehicle that is stopped (box 4).

According to this procedure, the sensor measures at a predetermined frequency, for example every minute, the surrounding temperature and pressure (box 6). The result of these measurements is then analyzed (box 8) with reference to the results of the preceding measurements which have been stored in an electronic memory. The latter is located with the sensor and is for example integrated with the sensor's management and control device. This analysis consists, for example, in determining the variation in pressure between two successive measurements, in calculating the derivative with respect to time of the pressure and of the temperature and finally to check that the values thus calculated remain within predetermined acceptable limits.

The results of the measurements taken and the results of the analysis are stored (box 10).

This process is carried out at a predetermined frequency as long as the vehicle is stopped. In order not to saturate the memory, it is for example possible to retain in memory only the last n measurements of temperature and pressure and, for example, the last measurement of pressure and temperature taken before the stoppage of the vehicle. Similarly, all of the results of the analyses of measurements are not necessarily retained in memory. Therefore only “interesting” results are retained in memory, that is to say results for which the pressure variation was large or sudden. It is possible to associate these results retained in memory with their acquisition dates.

The accelerometer, or similar, is always on standby and detects a restarting of the vehicle. When such a restarting is detected (box 12), the information that has been stored during the stoppage of the vehicle which is ended is transmitted several times to the central unit installed in the vehicle. The transmission is sufficiently frequent to guarantee that all of the data are correctly transmitted to the central unit (box 14). The central unit quickly notices if a suspect pressure variation has been detected during the stoppage of the vehicle. In fact, as the results of the measurements have already been analyzed by the sensor during the stoppage of the vehicle, the result of the monitoring of the corresponding tire state is immediately available. If no abnormal variation has been detected, provision can even be made for no transmission to be made to the central unit. A transmission is carried out only if an alarm must be triggered.

Consequently, during the movement phase, the management and control process of the sensor and of the transmitter is carried out according to a predetermined method (box 16). This process is not described in detail here. It can for example consist of taking measurements at regular time intervals, for example every 30 seconds, and of the transmitting the result of these measurements to the central unit installed in the vehicle which then analyses this data and triggers an alarm if necessary.

According to the method described above, the system located in the tire and intended to measure the temperature and pressure inside the latter is capable of producing a log and an analysis of the evolution of the measured parameters in order to determine, in an autonomous manner, phenomena that are important to detect whilst stopped, such as a readjustment of pressure or a significant leakage. Thus, even if this system is momentarily incapable of transmitting the results of its measurements to the central unit for any reason at all (for example transmitter positioned in an area screened from RF), pertinent data will be transmitted as soon as the vehicle starts moving.

The method described above has the advantage of being able to be used with the sensors and transmitters currently used for tire pressure monitoring systems. No additional hardware cost is therefore necessary in order to apply the invention to a vehicle equipped with such a system.

The method according to the invention allows the tire pressure monitoring device to distinguish between a rapid variation and slow variation in pressure. It thus distinguishes a slow evolution due, for example, to a variation in temperature from a rapid variation and also a readjustment of pressure followed by a slow evolution in the direction opposite to the readjustment of a pressure maintained virtually constant.

The invention is not limited to the embodiment described above by way non-restrictive example. It also relates to all variant embodiments within the scope of the following claims.

1. A method of transmitting measurements from a sensor to a central unit by a wireless link, such as a radio link for example, in a motor vehicle or similar, characterized in that it comprises the following steps:
detection of the stopped state of the vehicle (2),
measurement by the sensor of a parameter such as pressure (6) for example,
storage of the result of the measurement within the sensor (10),
analysis, at the level of the sensor, of the measurement with reference to the preceding measurements (8),
storage of the significant results of the analysis within the sensor (10), and
when the vehicle is moving again, transmission (14) by the sensor, if necessary, to the central unit of significant data on the events that have occurred since the last detected stoppage of the vehicle:

2. The method as claimed in claim 1, characterized in that a plurality of transmissions (14) are carried out by the sensor to the central unit when a starting of the vehicle is detected.

3. The method as claimed in either one of claims 1 and 2, characterized in that the measurements taken by the sensor whilst the vehicle is stopped are taken at a predetermined frequency.

4. The method as claimed in claim 3, characterized in that the frequency of the measurements is lower when the vehicle is stopped than when it is moving.

5. The method as claimed in one of claims 1 to 4, characterized in that, when the vehicle starts again, the sensor transmits to the central unit only the information relating to a sudden and/or abnormal variation of the measured parameter.

6. The method as claimed in one of claims 1 to 5, characterized in that the sensor measures both a pressure and a temperature.

7. The method as claimed in one of claims 1 to 6, characterized in that during the analysis of the measurements taken, the sensor calculates the derivative of the measured parameter with respect to time.

8. The method as claimed in one of claims 1 to 7, characterized in that the sensor stores both the measurements taken and the dates on which they were taken.

9. The method as claimed in one of claims 1 to 8, characterized in that the detection of the movement and/or the stoppage of the vehicle is carried out by an accelerometer.

10. Application of the method as claimed in one of claims 1 to 9 to a system for monitoring a motor vehicle's tire pressures.
